(19) United States
(12) Patent Application Publication
(10) Pub. No.: US 2021/0146863 A1
(43) Pub. Date: May 20, 2021

(54) Apparatus used for voiding in a vehicle

(71) Applicant: Dorsette Mapp, Brooklyn, NY (US)

(72) Inventor: Dorsette Mapp, Brooklyn, NY (US)

(21) Appl. No.: 16/035,167

(22) Filed: Jul. 13, 2018

(51) Int. Cl. B60R 15/04; A47K 11/12

(52) U.S. Cl. CPC B60R 15/04; A47K 11/12

(57) ABSTRACT

Car potty with absorbent receptacle lining that enables voiding in a vehicle.

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF INVENTION

The present application relates to an apparatus for voiding in a vehicle. Its intellectual property is a receptacle with an absorptive disposable receptacle lining that catches the urine. The absorptive nature of the lining allows for the spill free character of the apparatus. The present alternative is a diaper/undergarment, bottle or container.

Presently, there are no car toilet; and an individual traveling in a vehicle for long distances, caught in traffic, taking medication that cause frequent urination, a potty trained toddler, or a small child does not have a place to void. Bottles and containers can be used but they cause spills and are messy. For most adults, they will not wear diaper/undergarment, if they are not ill. Neither will toddlers who have been potty trained. In addition, undergarments presents further issues. For one, a diaper must be applied before a trip begins; and it can be uncomfortable and bulky, especially when soiled. When wearing a diaper/undergarment, stops must still be made to the bathroom to clean diaper/undergarment area, and to change to prevent skin irritation and discomfort.

Although a car potty is specifically made for a car it accommodates the elderly inside the house. low toilet seats present a difficult situation of getting up from a low level sitting position. Presently there are booster seats and commodes to accommodate an adult. The problem with booster seats it that they can only be used in the toilet. The car potty can move from one room to the other, it saves space, and can be placed on any height (chair or bed), thereby preventing other issues like falls which is possible when getting up from a low seat. Commodes have low seats also, and they are made with a large container to store urine, and stored urine gives off a bad smell. A commode also takes up a large space compare to a car potty. Holding urine for long periods, non-compliant with diuretics medications because of the unavailability of a place to urinate while travelling in a car, accidents due to standing in long lines, spills from urinating in containers that are not made for voiding, and the standard household low toilet seat for adults, can all be solved with the car potty. It also gives a peace of mind when travelling with children.

### BRIEF SUMMARY OF INVENTION

The general idea of this invention is to have an apparatus to void in while travelling in a vehicle, or to have a place to void, where no public facility is available. This invention has two versions. The female version that has a seat to sit on, and a male hand held version that is used by a male sitting or standing. What is new about the female potty version is its convertibility from an adult fit to a child's fit, its base-less receptacle, and its inner lining. What is old is that it can be used in conjunction with a standard toilet bowl to accommodate a child's buttocks, because it's no-base receptacle fits into a standard toilet bowl opening. What is also old is that it can be moved from place to place like a bed pan and can be placed on any comfortable surface to be used for height convenience, and to accommodate an adult bending ability. What is new in the male version is its receptacle lining, its no-base receptacle, and its opening at the side for a comfortable void. Some of the advantages of both versions of a car potty are that it provide a clean alternative to a public bathroom, it is spill free, easy to clean because of its disposable lining, it saves time on the road, and one is able to void where there is no restroom. Some examples of the above mentioned advantages of both versions are: (1) if one is at a park where there is either no bathroom or a dirty bathroom, one can return to the car for voiding. (2) It allows for easing bladder discomfort in traffic. (3) It eliminates the need to wear a bulky uncomfortable diaper/undergarment. (4) Because of their receptacle lining and portability, they can be placed on a bed or chair to be used when needed. This invention solve the problems, of not being able to void while travelling in the vehicle. When used as its invented purpose (with its lining), it cannot be used in conjunction with the standard toilet bowl. But when used without the lining, it can be used in conjunction with the standard toilet bowl. A receptacle lining can be used for one or more voids. However, because the lining can be disposed of at anytime, it eliminates the bad smell of pooled urine.

### BRIEF DESCRIPTION OF SEVERAL VIEWS OF THE DRAWINGS

### Female Version

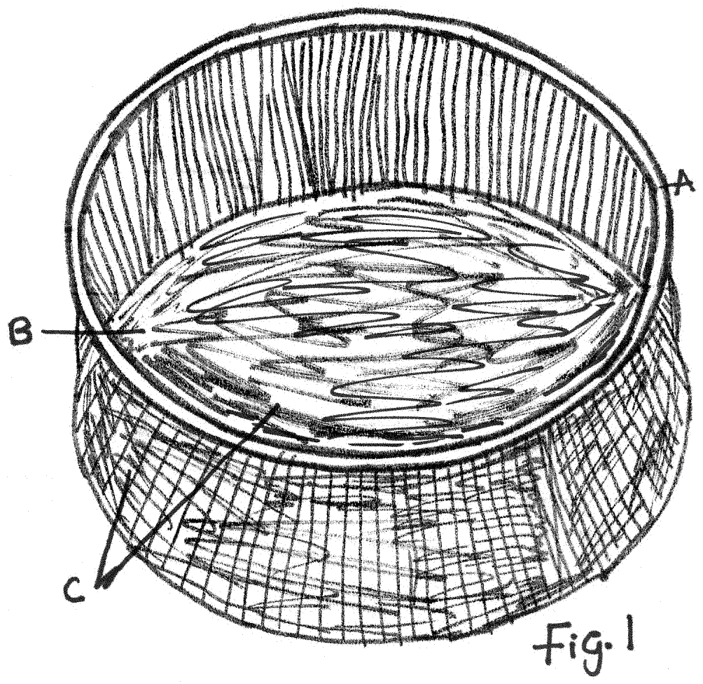

FIG. 1 Shows top view of female version receptacle lining

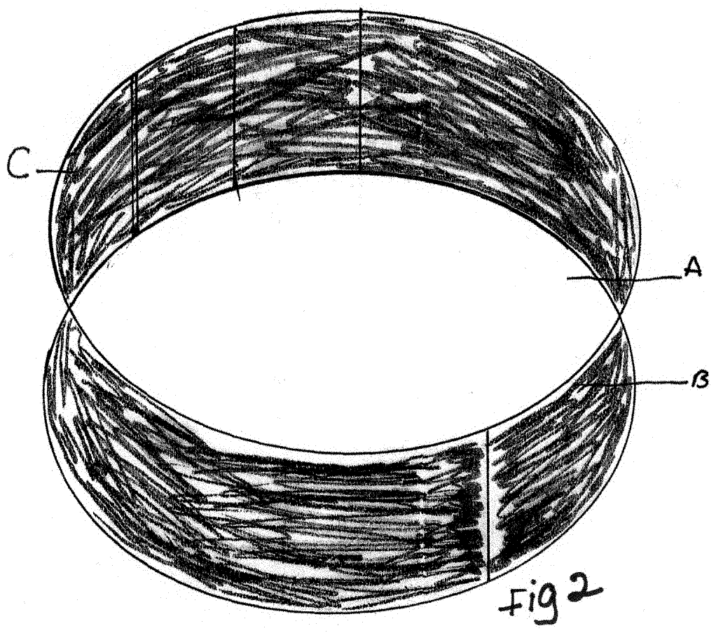

FIG. 2 Shows top view of female version receptacle

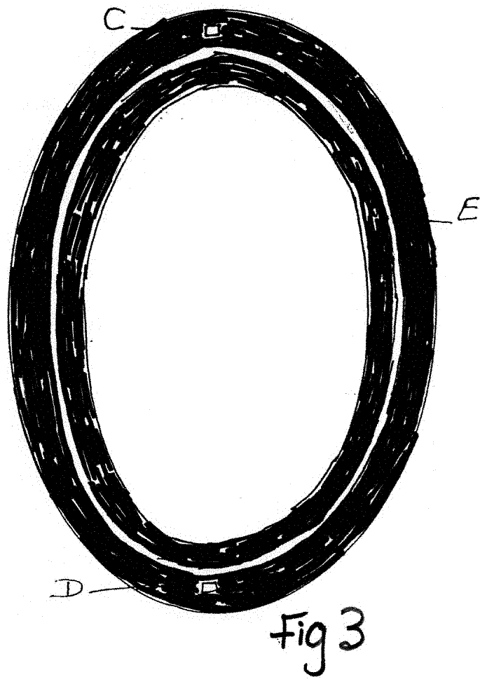

FIG. 3 Shows bottom view of female version adult seat

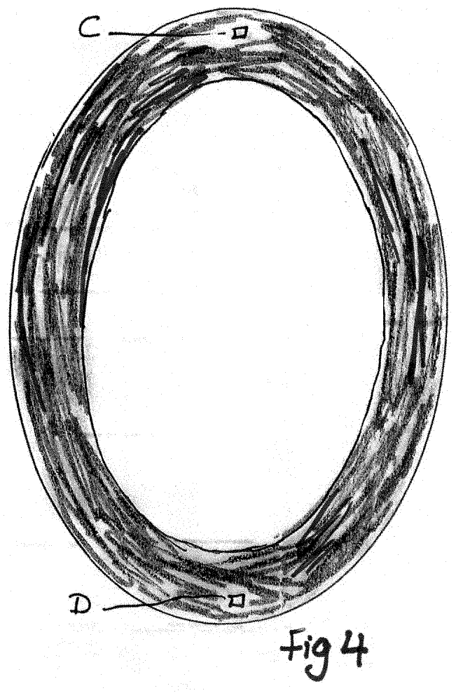

FIG. 4 Shows top view of female version adult seat

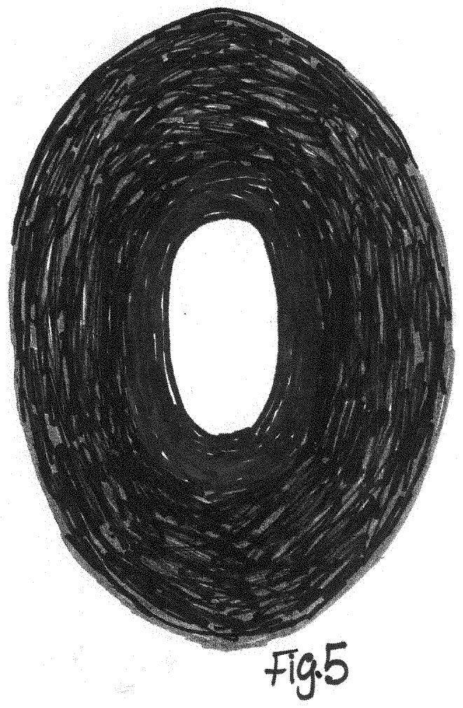

FIG. 5 Shows top view of female version child seat

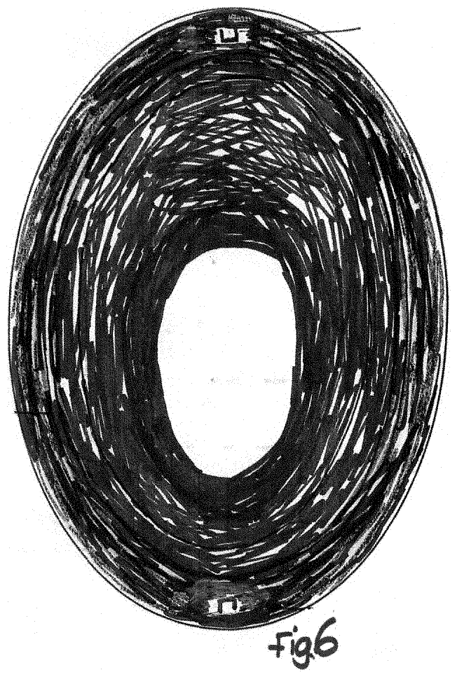

FIG. 6 Shows bottom view of female version child seat

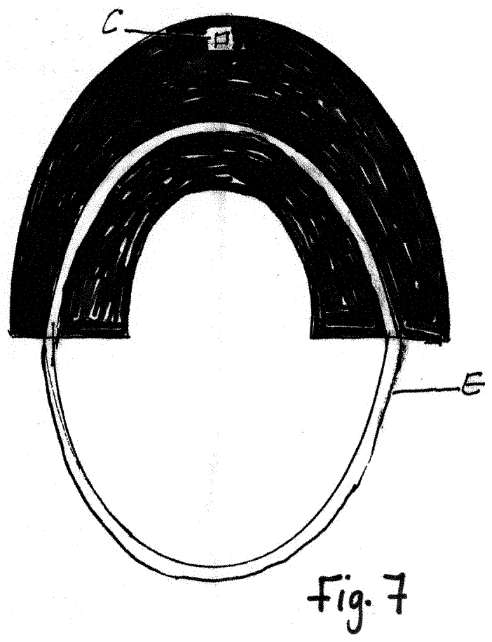

FIG. 7 Shows bottom view of female version adult seat with circular track.

### Male Version

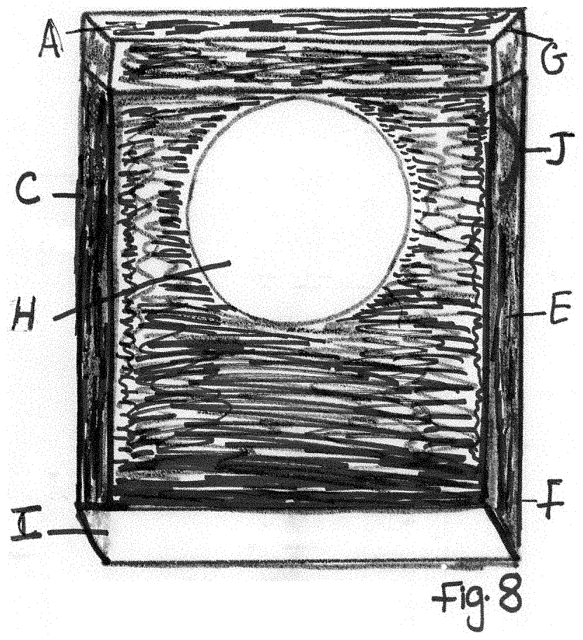

FIG. 8 Shows the front view of the receptacle for the male version.

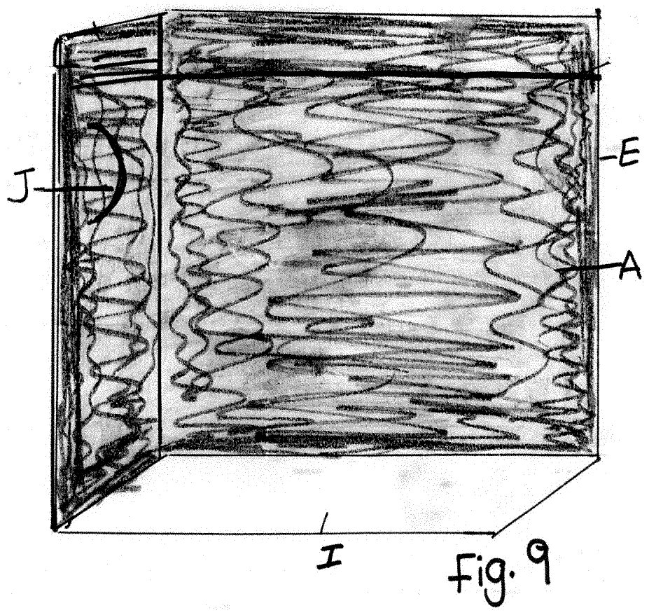

FIG. 9 Shows the back view of the receptacle for the male version

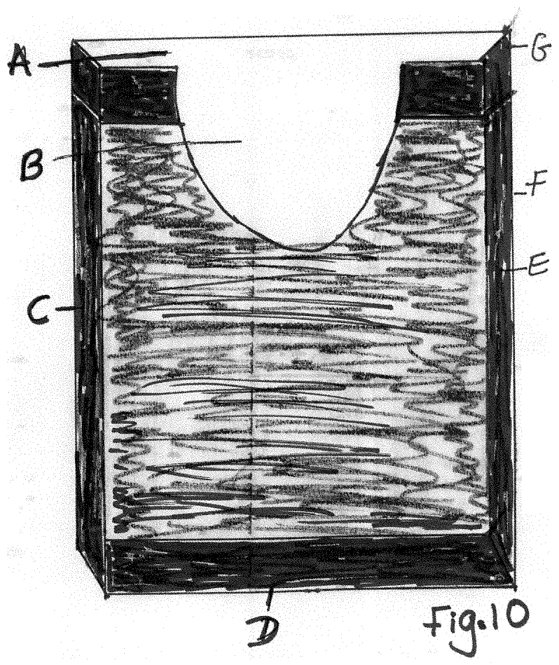

FIG. 10 Shows the front view of the receptacle lining of the male version.

FIG. 11 Shows the cover for the receptacle of the male version.

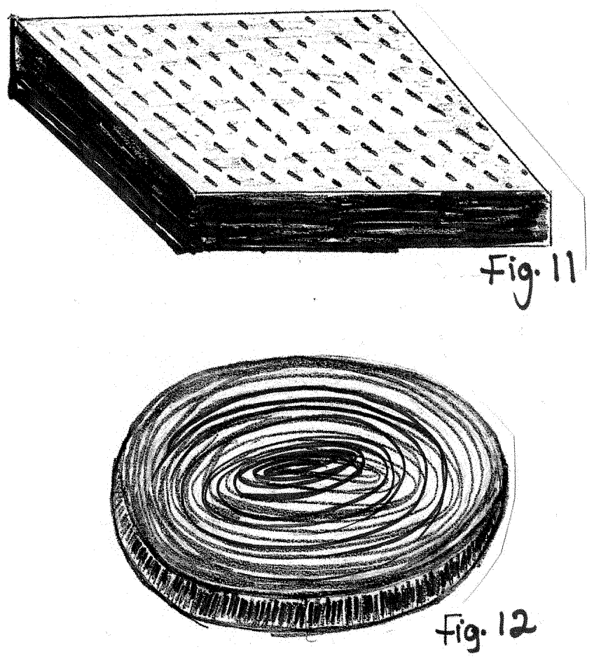

FIG. 12 Shows the void hole cap.

### DETAIL DESCRIPTION OF THE INVENTION

The car potty is an apparatus invented to be used in a car for voiding. The female version has 4 parts. 2 seats, one to fit an adult buttocks (FIG. 4) the other to fit a child's buttocks (FIG. 5). A receptacle (FIG. 2), and a receptacle lining (FIG. 1). The two seats and the receptacle are made from hard plastic, strong enough to hold the weight of an adult. The child's seat (FIG. 5) is made to fit on top of the adult seat. When a child is using the potty, the child's seat is placed on top of the adult seat, and is kept in place via two slots on the adult seat (one centrally placed in the back FIG. 4 (C), and one centrally placed in the front FIG. 4 (D) The child's seat has 2 notches at the bottom. One centrally placed in the back 6 (A) FIG and one centrally placed in the front FIG. 6 (B) These notches fit in the two slots on the adult seat to keep the child seat in place. The adult seat must always be in place when the potty is being used by child or adult for two reasons, (1) the child seat cannot be used to sit on by itself; it need the support and stability the adult seat provides; and (2) underneath the adult seat is a track that keeps the receptacle and receptacle lining in place. There is nothing to hold the child's seat to the receptacle. Only the adult seat will be in direct contact with the receptacle. The child's seat always sits on the adult seat for the child to use, and comes off when the adult uses the potty. The receptacle (FIG. 2) is like a circular band with a width of 3″ in the shape and size of a standard toilet bowl opening. It has no base. The receptacle lining (FIG. 1), is made from absorptive material to absorpt the voided urine. Its outer layer is made of plastic material to prevent leakage. The diameter of the receptacle and the receptacle lining are almost the same size, with the lining a tad bit smaller in diameter making the lining fit snugly in the receptacle. The receptacle lining is also a ¼″ longer than the receptacle. That extra ¼″ folds over the top of the receptacle and has two purposes. It keeps the lining in place, and it provides for a tight fit of the receptacle top and the hollow track underneath the adult seat.

To put the apparatus together for use, the receptacle lining is placed within the receptacle, and the extra ¼″ of the receptacle lining is then folded over the top of the receptacle. The adult seat is then placed (tract side down) on top of the receptacle, sandwiching the receptacle top between its circular track. The tightly fitted tract will keep the receptacle and its lining in place. At this point the apparatus is ready for adult use. Next, the child's seat is placed over the adult seat, and is kept in place via the slots on the adult seat, and the notches on the child's seat. It is now ready to be use by a child. To dispose a soiled receptacle lining, both seats are separated from the receptacle, and the lining taken out and dispose.

The male version has four parts. The no-base hand held receptacle, FIG. 8. Features a hand held handle (J), and a void hole (H). to void through. A void hole cap FIG. 12 to contain all voided material within the apparatus. A top cover FIG. 11 which holds the receptacle lining in place, and holds all the voided material in the receptacle. A receptacle lining FIG. 10 featuring a cut-out area (B) that aligns with the void hole of the receptacle. This lining is a tid bit smaller than the receptacle so that it fits snugly within the receptacle. To change the lining, the cover is removed from the top, the lining is taken out and dispose of.

1. Car potty with absorbent receptacle lining that enables voiding in a vehicle.
